(19) United States
(12) Patent Application Publication
(10) Pub. No.: US 2002/0086689 A1
(43) Pub. Date: Jul. 4, 2002

(54) Rerouting wireless messages to locate service providers

(76) Inventors: Brian Moran, Preston, WA (US); David Feinleib, Kirkland, WA (US); Chuck Mount, Kirkland, WA (US)

Correspondence Address: R. Alan Burnett, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/033,447

(22) Filed: Dec. 27, 2001

Related U.S. Application Data
(60) Provisional application No. 60/258,751, filed on Dec. 28, 2000.

(51) Int. Cl. H04Q 7/20

(52) U.S. Cl. 455/466; 455/403; 455/517

(57) ABSTRACT

A method for rerouting wireless messages to locate service providers for destination devices that use different service providers than sending devices. In one embodiment, the method begins with a request to send a wireless message from a sending device that uses a first service provider to a destination device that uses a second service provider. Based on a phone number reference in the message, potential service providers for the destination device are identified. Ping messages are then sent to each of these potential service providers, while checking for a successful response. The message is then sent to the destination device via a service provider who successfully responds to the ping message sent to it. A phone map table that maps phone numbers to message service providers may also be used to reroute messages. The phone map table is updated in response to successful ping messages.

### RELATED APPLICATIONS

The present application is based on a co-pending provisional application entitled “REROUTING WIRELESS MESSAGES TO LOCATE SERVICE PROVIDERS, ” Serial No. 60/258,751, filed on Dec. 28, 2000, the benefit of the filing date of which is claimed under 35 U.S.C. § 119(e).

### BACKGROUND OF THE INVENTION

1. Field of the Invention

The present invention generally concerns wireless messaging services, and in more particular concerns a method and system for determining new service providers for users who have switched wireless services, and rerouting messages so that they are received by those users via their new service providers.

2. Background Information

Under the present wireless bandwidth allocation scheme in the United States, there are several wireless service providers for each metropolitan market, and generally at least two service providers for rural markets. Unlike other areas of the world, such as Europe, the various service providers for a given U.S. market generally do not provide messaging cross-compatibility with other service providers in that market. This problem is illustrated in FIG. 1, wherein a plurality of users having different service providers are depicted. These users include AT&T Wireless users 1 and 2, Verizon Wireless users 1 & 2, Voicestream users 1 & 2, and Sprint PCS users 1 and 2.

In many instances, the user of a particular wireless service provider will only be able to send text messages to other users who use the same provider. For example, AT&T user 1 can send a text message to AT&T user 2 via wireless communication paths 10 and 12. Path 10 comprises the route from a cellular phone 14 that uses AT&T wireless for its service provider to an AT&T wireless short messaging service center (SMSC) 16 via a cellular antenna 18. Path 12 comprises the route from AT&T wireless SMSC 16 via cellular antenna 18 to a cellular phone 20 that also uses AT&T wireless as its service provider. As will be recognized by those skilled in the art, the actual connection path from a cellular phone to another cellular phone and/or an SMCS may comprise several cellular antennas; however, for simplicity, each of the connection paths described herein comprise only a few cellular antennas at most.

In addition to paths 10 and 12, there are other paths illustrated in FIG. 1 that successfully link users operating phones having a common service provider, including paths 22 and 24, which enables Verizon user 1 to send a text message from a cellular phone 26 via cellular antenna 18, a Verizon SMSC 28, and a cellular antenna 30 to a cellular phone 32 operated by Verizon user 2. Similarly, paths 32 and 34 enable text messaging between cellular phones 36 and 38 respectively operated by Voicestream users 1 and 2 via cellular antennas 18 and 30 and a Voicestream SMSC 40, while paths 42 and 44 enable text messaging between PCS phones 46 and 48 via cellular antennas 18 and 30 and a Sprint PCS SMSC 50.

Although there are instances in which service providers provide some cross-compatibility for text messaging, there are many markets in which the user audience for text messaging is greatly restricted to only those users who have the same service provider. For example, AT&T wireless user 1 may not be able to send text messages to any Verizon user, any Voicestream user, or an Sprint PCS user, as provided by failure paths 52, each of which is depicted as a dashed line with an “X” in FIG. 1. Similar failure paths 52 are shown in the Figure to illustrate the lack of cross-compatibility for text messaging when the sending phone and the receiving phone use different service providers.

The foregoing problem is exacerbated when users are able to switch service providers while maintaining the same phone number for their devices. Generally, each service provider is allocated a particular set of prefixes for a given market. Also, most wireless devices are configured to use a predetermined phone number. Furthermore, many phone models are manufactured specifically for a particular service provider, whereby they only can receive service from that service provider. Accordingly, a user's service provider can often be determined based on the phone number of the user's device and/or the model of the user's device.

Recent market changes have broken the device/service provider tie in many service areas. For example, in some areas of Asia, such as Hong Kong, users are able to switch service providers while keeping the same phone number (and corresponding wireless device) they were previously using. This creates a problem with respect to wireless messages. Since wireless messages sent to a destination device often need to be sent via the service provider for the destination device, it is imperative that this service provider be known. In many instances, if the service provider cannot be determined, the message will never reach the destination device. It would therefore be desirable to provide a scheme that would enable identification of the new service providers of users who have switched providers while maintaining their equipment and phone number, and for messages to be delivered to users who have changed their service providers.

### SUMMARY OF THE INVENTION

A method for rerouting wireless messages to locate service providers for destination devices that use different service providers than sending devices. The method begins with a request to send a wireless message from a sending device that uses a first service provider to a destination device that uses a second service provider. The phone number for the destination device is included in the message or attached thereto. In one embodiment, a phone map table that maps phone numbers to message service providers is checked to determine the second service provider. If an appropriate service provider is identified, the message is sent to the destination device via that service provider with any reformatting that may be required.

If an appropriate service provider is not identified via the phone map table, a list of potential service providers for the destination device are identified. In one embodiment the list is identified based on the area code and/or prefix for the destination device phone number. Ping messages are then sent to each of these potential service providers, while checking for a successful response. The message is then sent to the destination device via a service provider who successfully responds to the ping message sent to it. The phone map table is also updated in response to successful ping messages.

Another aspect of the invention pertains to rerouting messages that are sent from sending devices while roaming. A user request to send a message while roaming to a destination device. The message is routed to the roaming carrier message center, as would normally be done. The message is then intercepted and redirected to a different SMSC (short messaging service center) than the user's home carrier SMSC. The message is then routed through the different SMSC and delivered to the destination device.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram illustrating a conventional prior art infrastructure used to send text messages to wireless devices;

FIG. 2 is a schematic drawing of an exemplary system for implementing the present invention;

FIG. 3 is a schematic diagram corresponding to the system of FIG. 2 that includes further detail of the rerouting service provided by the present invention;

FIG. 4 is a flowchart illustrating the logic used by the present invention to reroute messages to wireless destination devices;

FIG. 5 is an entity relationship diagram corresponding to an exemplary database schema for implementing the database aspects of the invention;

FIG. 6 is a schematic diagram corresponding to an exemplary system for rerouting messages while roaming;

FIG. 7 is a flowchart illustrating the logic used by the present invention to reroute messages when the message is sent via a roaming device; and

FIG. 8 is a schematic drawing of a computer system that may be implemented for various components in the system of the present invention.

### DETAILED DESCRIPTION

The present invention addresses the foregoing cross-connectivity problem by providing a method and system that enables wireless device users to send text messages to other wireless device users having different service providers. The method and system are enabled through use of a third party rerouting/reformatting service that appears transparent to the wireless device users and service providers. The method includes appending a domain name to a destination identifier (e.g., the phone number for a destination wireless device), enabling the text message to be sent as an email rather than a convention wireless device text message. Accordingly, the message can be rerouted using existing email routing infrastructure, including routing via the Internet and other networks. The method and system also include a mechanism for rerouting messages from roaming users such that the messages are routed via the roaming service provider's messaging infrastructure, thereby enabling the roaming service provider to bill for and/or control the use of such messaging services.

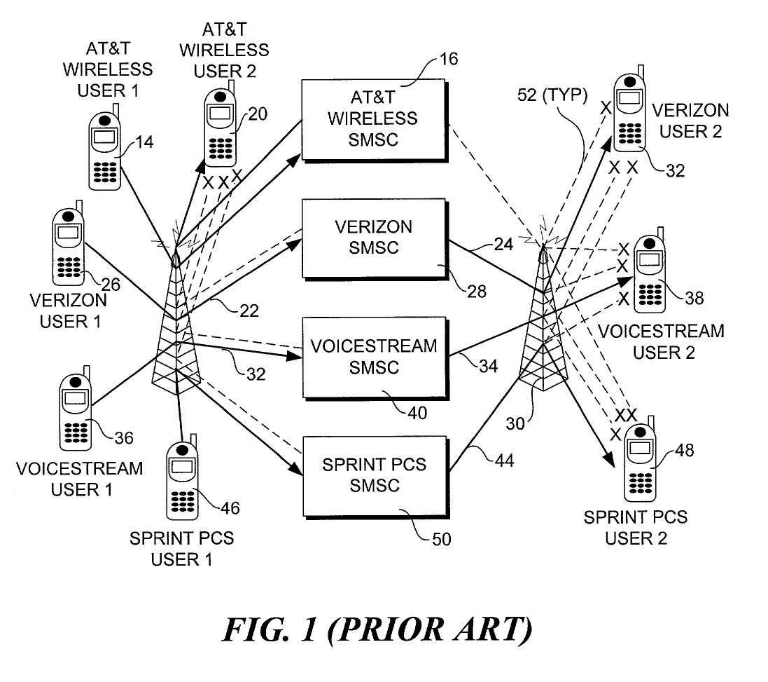

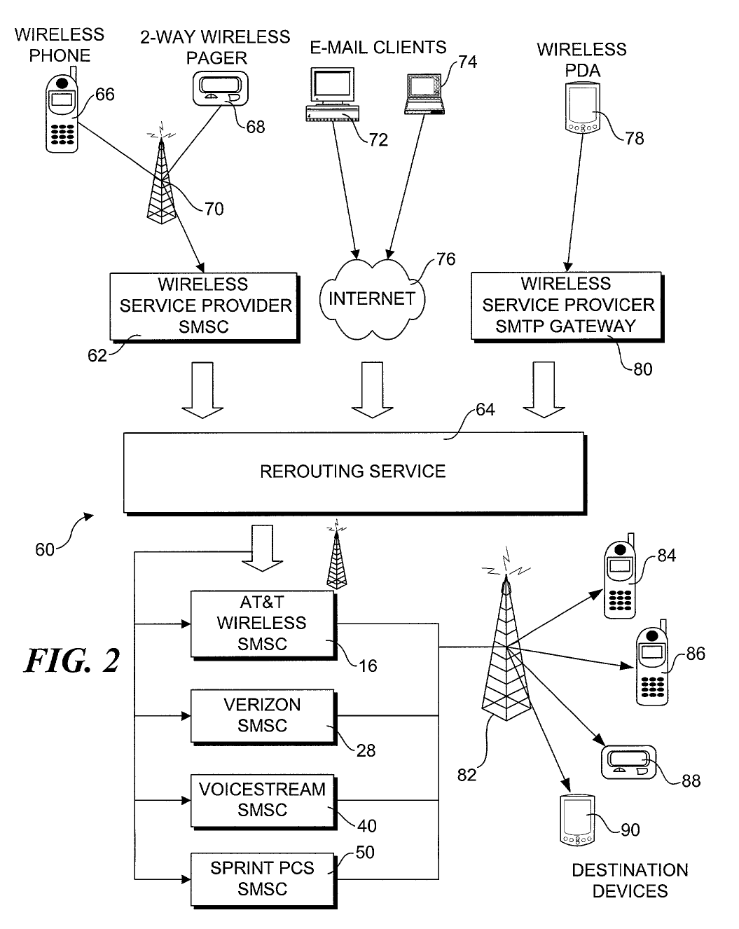

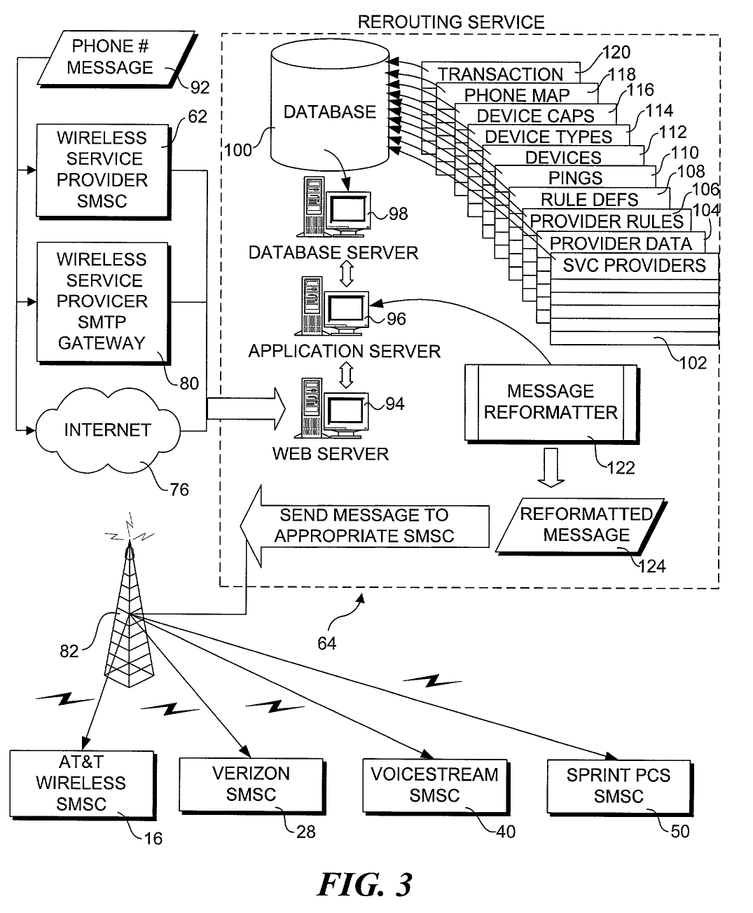

An exemplary system 60 for implementing the present invention is shown in FIGS. 2 and 3. As will be recognized by those skilled in the art, FIG. 2 depicts various conventional wireless infrastructure components, including many of the infrastructure components illustrated in FIG. 1 and discussed above, wherein like-numbered components perform substantially the same functions. In addition, wireless service provider SMSCs 16, 28, 40, and 50, as well as SMSCs for other service providers, are collectively represented by a wireless service provider SMSC 62 in FIG. 2.

System 60 enables users using various types of wireless and landbased devices to send messages to selected wireless destination devices through services provided by a rerouting service 64. As explained in further detail below, rerouting service 64 receives messages from the various user devices, along with a phone number for a destination device to which the message is to be delivered. Upon receiving a message, rerouting service 64 identifies the service provider for the destination device, reformats the message, as necessary, and forwards the message to that service provider so that it can be delivered to the destination device.

For example, a user of a wireless phone 66 or a two-way wireless pager 68 can create a message and send it via a cellular antenna 70 to an appropriate SMSC corresponding to the service provider for the cell phone or page (as depicted by wireless service provider SMSC 62), which will then direct the message to rerouting service 64. In other instances, an e-mail client, such as a user operating a computer 72 or a laptop 74, may create an e-mail message that is to be delivered to a wireless destination device. In this instance, the e-mail may be delivered to rerouting service 64 by sending the message with appropriate routing via one or more networks 76, such as the Internet. In another case, a user of a wireless PDA device 78, such as a palm pilot or handheld computer, can send a message to rerouting service 64 via a SMPT (simple mail transport protocol) gateway provided by an appropriate service provider for PDA device 78, as depicted by a wireless service provider SMTP Gateway 80.

Once a message is received by the rerouting service 64, the service provider for the destination device is identified based on the phone number for the destination device, which will be delivered along with the message. If necessary, the message will first be reformatted to meet that particular requirements of text messaging for that service provider, and then sent to the appropriate SMSC for that provider, as illustrated by AT&T wireless SMSC 16, Verizon SMSC 28, Voicestream SMSC 40, and Sprint SMSC 50. Upon receiving the message at its SMSC, the service provider will deliver the message to the selected wireless destination device via a cellular antenna 82, as depicted by cellular phones 84 and 86, a wireless pager 88, and a wireless PDA device 90.

The primary components used in an exemplary configuration by rerouting service 64 are depicted in FIG. 3. Rerouting service 64 receives incoming e-mail messages 92 forwarded by wireless service provider SMSC 62, wireless service provider SMTP gateway 80, and Internet 76 a web server 94. Preferably, communication with web server 94 will be enabled through one or more URLs that are used as access points to the system. Web server 94 is connected in communication with an application server 96, which in turn is connected in communication with a database server 98. As will be understood by those skilled in the art, each of web server 94, application server 96, and database server 98 may run on one or more separate machines in a distributed multi-tier environment, or may be run on two machines, or even a single machine. For instance, it is common to use a single machine to perform web server and application server functions.

Preferably, database server 98 will comprise a relational database management system (RDBMS) database server, such as the SQL (structured query language) database servers provided by Oracle (Oracle 8i), Microsoft (SQLserver), Informix, IBM (DB2), or Sybase. Database server 98 operates on data stored in a database 100 having an exemplary schema that includes a service providers table 102, a provider data table 104, a provider rules table 106, a rules definition table 108, a ping table 110, a devices table 112, a device types table 114, a devices capability table 116, a phone number-to-service provider mapping (phone map) table 118, and a transaction table 120

Application server 96 includes one or more software modules comprising a message reformattor 122 that generates reformatted messages 124 based on corresponding e-mail messages 92 and data stored in database 100. Messages 124 are reformatted to meet the particular requirements of the service provider for a selected destination device, capabilities of the destination device, and any applicable rules corresponding to the service provider for the destination device. Messages 98 are then sent to a selected destination device via an appropriate SMSC corresponding to the service provider for the destination device.

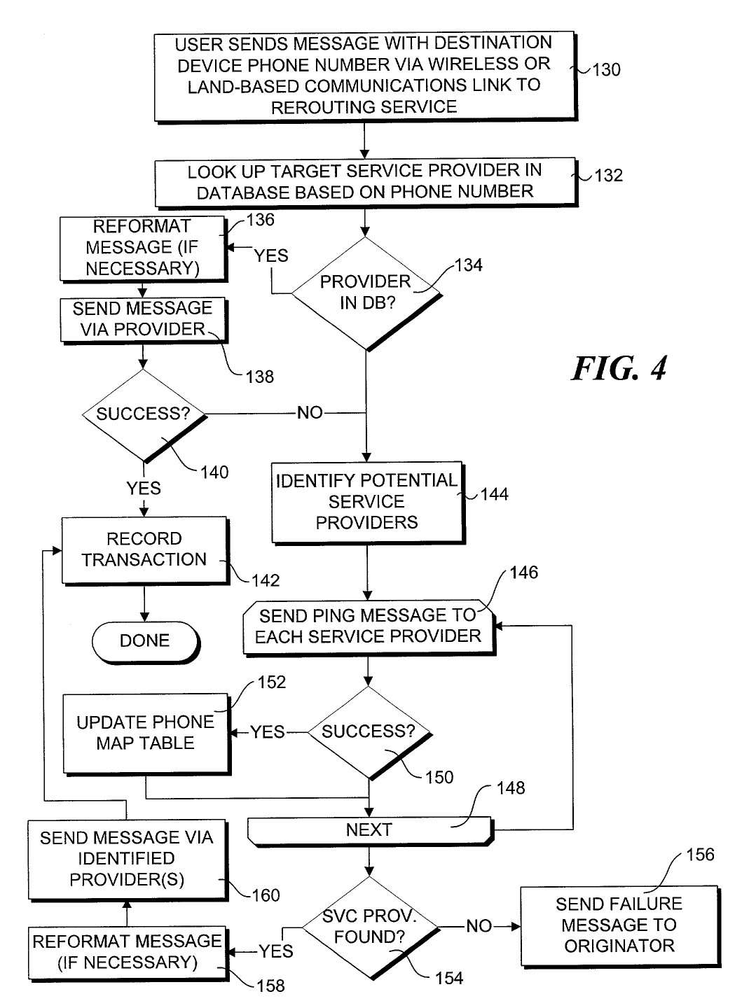

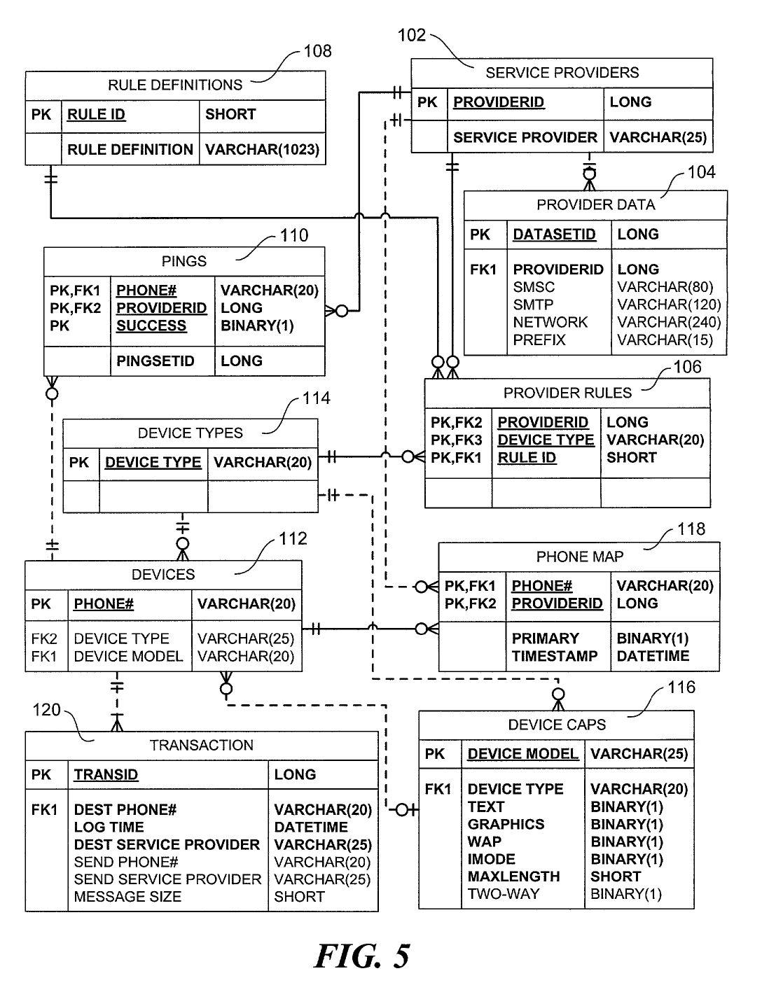

The logic for an exemplary implementation of the invention is now described with reference to the logic flowchart of FIG. 4 and the database schema diagram shown in FIG. 5. The process begins in a block 130, in which a user sends a message along with data corresponding to the phone number of a destination device. As discussed above, the user may send the message from a wireless device, such as a cellular phone or pager, a desktop computer, a laptop computer, a PDA, or any other type of device that can send a text message targeted to be received by a wireless destination device. The message is sent via an appropriate routing mechanism (e.g., SMSC, Internet, SMTP Gateway, etc.) so that it is received by rerouting service 64.

Upon receiving the message, rerouting service 64 attempts to find a service provider for the phone number of the destination device in database 100, as provided by a block 132. Preferably, information of this type, i.e., data that maps a given phone number to a service provider, will be stored in phone map table 118. Initially, such information may be provided by the service providers for a given market. In addition, in markets where service providers share messaging facilities and/or provide cross-compatible messaging services, there may be more than one service provider listed for a particular phone number. Accordingly, the “service provider” (which may be extracted from service providers table 102 based on the providerID in phone map table 118) for a given phone number may include both the primary service provider for the corresponding wireless device and one or more other service providers that provide messaging services to the phone number. Preferably, the primary service provider for the phone number will be indicated in phone map table 118, e.g., by marking a flag in the “Primary” column of the table.

As provided by a decision block 134, if one or more service providers are found, an attempt to send the message via the service provider(s) may be performed. However, some messages may be have to be reformatted prior to being sent, depending on the particular requirements of the service provider and the destination device. Message reformatting, if needed, is performed in a block 136. For example, certain service providers will have particular content formatting rules. The applicable rules for each service provider and/or service provider/device combination may be stored through the combination of provider rules table 106 and rules definition table 108. In addition, formatting requirements for particular devices may be extracted from data in devices table 112, and device capabilities table 116. As will be recognized by those skilled in the art, similar rules, indicators to apply such rules for particular service providers and/or devices, and device capabilities may be stored in one or more datafiles that are accessible to applications running on application server 96, or stored in other tables in database 100. Preferably, any applicable rules for a given message will be extracted by message reformatter 122 and applied when generating reformatted message 124.

Once the message is reformatted, as necessary, the message is sent in a block 138 via one or more of the service providers identified in block 132 to the destination device. According to a first scheme, the message will be sent via a primary service provider if such a provider exists. Alternately, the message may be sent via all of the service providers identified in block 132.

The logic than proceeds to a decision block 140, in which a determination if made to whether the message was successfully delivered. In general, information concerning whether a message was delivered will be provided by the service provider used to deliver the message. If a successful delivery occurs, various transaction information is recorded in transaction table 120, as provided by a block 142, and the process is completed.

If either the message was not successfully delivered, or no service provider was found in block 132, the logic proceeds to a block 144 in which a list of potential service providers is generated. There are several ways that potential service providers may be identified. According to a first scheme, a list of service providers may be identified based on the prefix for the phone number of the destination device, wherein such data may be stored in a “Prefix” column of provider data 104. Optionally, if the type of destination device is known, such as whether the device is a cellular phone, a PCS phone, or pager, only service providers that support those types of devices should be identified. In addition, the available service provider(s) may be identified through the model number of the destination device. In the latter two instances, information for the type and model number of a particular device may be provided by one or more service providers that provide service for that device. Optionally, this information may be available from the manufacturer of the device.

Once the potential service providers are identified, a “ping” message is sent to the destination device via each service provider, as provided by a start loop block 146 and an end loop block 148. The ping test is used to determine if a message can be successfully delivered to the destination device through messaging services provided by a given service provider. Preferably, the results for each set of ping messages may be recorded in ping table 110. Optionally, these results may be stored in a temporary storage means, such as RAM, or in a datafile.

In accord with a decision block 150, if the ping message for a given service provider is successfully delivered, phone map table 118 is updated to with a new record mapping the destination device phone number to the service provider, as provided by a block 152.

Once all of the potential service providers have been pinged, to logic proceeds to a decision block 154, in which a determination is made to whether a service provider successfully delivered it corresponding ping message. If none of the service providers were successfully pinged, a failure message is sent back to the originating user (device) in a block 156.

If one or more of the ping tests is successful, the message is reformatted, as necessary, in a block 158, and sent via one or more of the service providers having a successful ping test to the destination device in a block 160. A record transaction is then recorded in block 142 and the process is complete.

### Rerouting Messages When Roaming

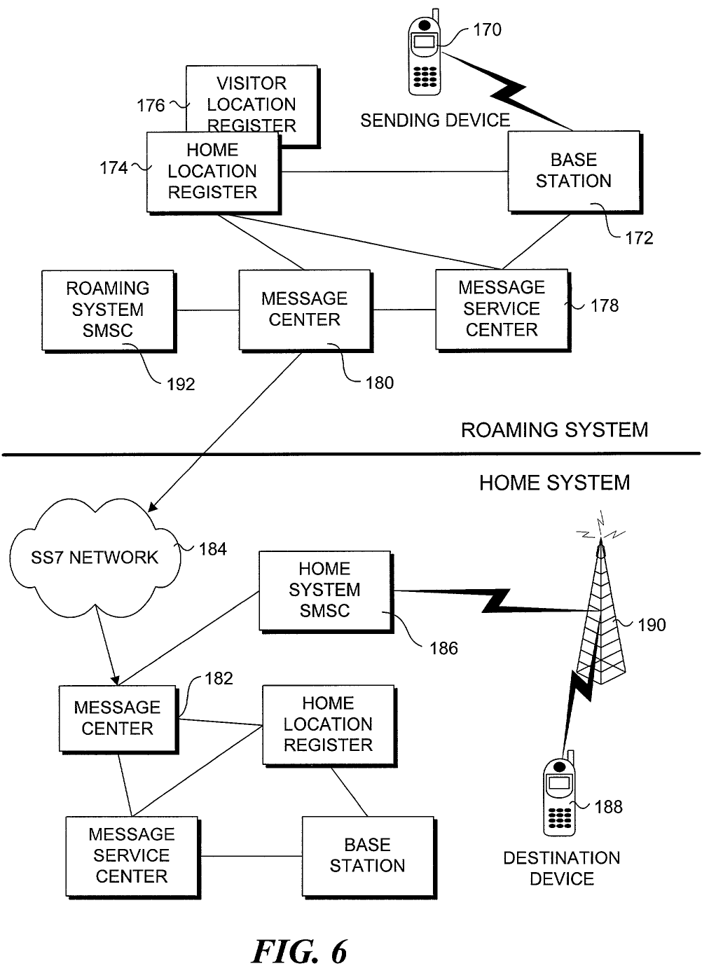

It is very common for users to send messages while they are “roaming”—that is, when they are away from an area covered by their “home” service provider (the home carrier) and thus are required to use another service provider (the roaming carrier) that provides wireless services for their present locality. Typically, a roaming user will be able to send a message through use of the roaming carrier's services without incurring an extra charge (there may be a charge for normal roaming usage). A typical process for sending a message in this fashion is illustrated in FIG. 6. The process begins with the user connecting to a local tower operated by the roaming carrier using one of the roaming carrier's control channels, as depicted by a sending device 170 and a base station 172. The user creates the message, and sends it to the phone number of a destination device. Base station 172 receives the request and determines whether the user is a home system user or a roaming user by looking up this information based on the phone number of the sending device in a home location register 174 and a visitor location register 176. If the user is roaming, the roaming system will forward the message to a message service center 176 and a message center 180. At this point, the message is routed to the home carrier's message center 182 via an SS7 (signaling system) network 184, or other type of network that provides services for wireless messaging. The message is then routed through the home carrier's SMSC 186 to a destination device 188 via an antenna 190.

A problem with the foregoing scenario is that the user is often able to use parts of the roaming carrier's network free of charge, and that the roaming carrier's control channel is a limited resource. For instance, billing charges for messaging are typically handled by a carrier's SMSC. In the foregoing example, the message was transferred to the destination device without going through the roaming system's SMSC 192. As a result, the roaming carrier may not be able to bill for the messaging service it provides. In addition to desiring to charge users for use of their part in transferring messages, the roaming carrier would also prefer to be able control this type of usage.

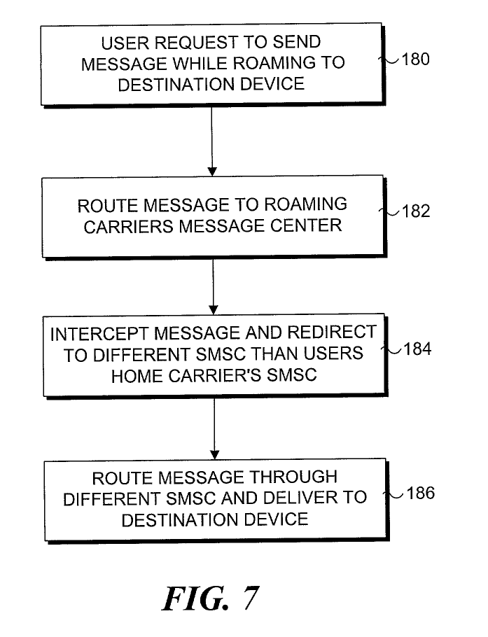

This present invention provides a scheme that enables carriers to control the routing of messages sent by roaming users so that the carrier can bill for and/or control such usages. With reference to FIG. 7, the process starts in a block 180 corresponding to a user requesting to sent a message while roaming to a destination device. In a block 182, the message is routed via to the roaming carriers control channel and other network infrastructure, as necessary, to the roaming carrier's message center. Upon being received by the roaming carrier's message center, the message is intercepted and redirected to a different SMSC than the user's home carrier's SMSC, as provided by a block 184. The message is then routed through the different carrier's SMSC to the destination device in a block 186. In the foregoing scenario, the different carrier typically will be the roaming carrier, but may be another third-party carrier as well.

A benefit provided by this scheme is that the call/message is routed through the different carrier's SMSC system, which will typically have a billing system and usage control mechanisms that are already in place. As a result, the different carrier can bill, route, and control these messages.

### Exemplary Machine for Implementing Portions of the System

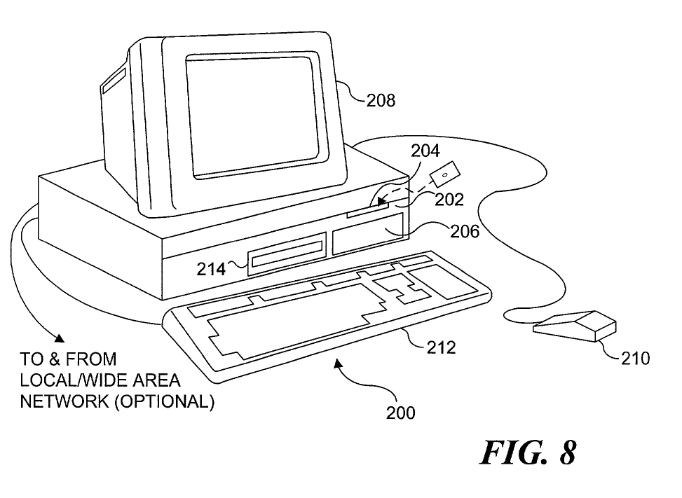

With reference to FIG. 8, a generally conventional personal computer 200 is illustrated, which is suitable for use in connection with practicing the present invention. Alternatively, a corresponding workstation on a local area network may be used for executing machine instructions comprising a computer program that causes the present invention to be executed. Personal computer 200 includes a processor chassis 202 in which are mounted a floppy disk drive 204, a hard drive 206, a motherboard populated with appropriate integrated circuits (not shown), and a power supply (also not shown), as are generally well known to those of ordinary skill in the art. A monitor 208 is included for displaying graphics and text generated by software programs that are run by the personal computer, and for graphically representing images and video frames produced by the present invention. A mouse 210 (or other pointing device) is connected to a serial port (or to a bus port) on the rear of processor chassis 202, and signals from mouse 210 are conveyed to the motherboard to control a cursor on the display and to select text, menu options, and graphic components displayed on monitor 208 by software programs executing on the personal computer, such as a photo editing program that implements the present invention. In addition, a keyboard 212 is coupled to the motherboard for user entry of text and commands that affect the running of software programs executing on the personal computer.

Personal computer 200 also optionally includes a compact disk-read only memory (CD-ROM) drive 214 into which a CD-ROM disk may be inserted so that executable files and data on the disk can be read for transfer into the memory and/or into storage on hard drive 206 of personal computer 200. Other mass memory storage devices such as an optical recorded medium or DVD drive may be included. The machine instructions comprising the software program that causes the CPU to implement the functions of the present invention that have been discussed above will likely be distributed on floppy disks or CD-ROMs (or other memory media) and stored in the hard drive until loaded into random access memory (RAM) for execution by the CPU.

Machines similar to computer 200 may be used for the various servers in the system. However, it is preferable that machines that are designed specifically for file and application server functions be implemented as such.

The above description of illustrated embodiments of the invention is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. Accordingly, it is not intended that the scope of the invention in any way be limited by the above description, but instead be determined entirely by reference to the claims that follow.

What is claimed is:

1. A method for rerouting a wireless message to locate a destination device service provider, comprising:
requesting to send a wireless message from a sending device that uses a first service provider to a destination device that uses a second service provider, said request referencing a phone number for the destination device;
identifying potential service providers for the destination device based on the phone number;
sending a ping message to each service provider identified as a potential service provider; and
sending the message to the destination device via a service provider that successfully responds to the ping message sent to it.

2. The method of claim 1, further comprising reformatting the message from a first message format used by the first service provider to a second message format used by the second service provider.

3. The method of claim 1, further comprising:
looking up a target service provider in a database mapping wireless device phone numbers to wireless device providers; and
sending the message via a service provider that is mapped to the phone number of the destination device.

4. The method of claim 1, further comprising:
maintaining a phone map table the maps wireless device phone numbers to corresponding service providers; and
updating the phone map table to map the destination device phone number to any service providers that successfully respond to the ping message sent to it.

5. The method of claim 1, further comprising sending a failure message back to the sending device if not service provider successfully responds to any of the ping messages.

6. The method of claim 1, further comprising recording a transaction corresponding to a successfully sent message, said transaction identifying the service providers used in rerouting the message.

7. A method for rerouting a message sent from a sending device while roaming, comprising:
requesting to send a message while roaming from the sending device to a destination device;
routing the message to a message center corresponding to a roaming carrier that currently provides wireless access service for the sending device;
intercepting the message and redirecting it to a different SMSC (short messaging service center) than an SMSC corresponding to a home carrier for the sending device; and
routing the message to the different SMSC to be delivered to the destination device.
